(19) United States
(12) Patent Application Publication
(10) Pub. No.: US 2024/0323933 A1
(43) Pub. Date: Sep. 26, 2024

(54) METHODS AND APPARATUSES FOR RESOURCE MULTIPLEXING

(71) Applicant: LENOVO (BEIJING) LIMITED, Beijing (CN)

(72) Inventors: Hongmei LIU, Beijing (CN); Zhi YAN, Beijing (CN); Yuantao ZHANG, Beijing (CN); Lianhai WU, Beijing (CN); Haiming WANG, Beijing (CN)

(21) Appl. No.: 18/579,442

(22) PCT Filed: Jul. 16, 2021
(86) PCT No.: PCT/CN2021/106786

§ 371 Date: Jan. 15, 2024

(51) Int. Cl. H04W 72/0446; H04W 72/232

(52) U.S. Cl. CPC H04W 72/0446; H04W 72/232

(57) ABSTRACT

The present application relates to methods and apparatuses for resource multiplexing. One embodiment of the present disclosure provides a method, comprising: receiving a first signaling via a first link, wherein the first signaling indicates a first time domain resource configuration of at least one multiplexing mode for the first link and a second link, and determining time domain resources associated with each multiplexing mode of the at least one multiplexing mode based on the first time domain resource configuration

### TECHNICAL FIELD

The present disclosure relates to wireless communication technologies, especially to methods and apparatuses for resource multiplexing.

### BACKGROUND OF THE INVENTION

In R17 integrated access and backhaul (IAB) Work Item Description (WID), in addition to time-division multiplexing mode (TDM), frequency-division multiplexing mode (FDM) and space division multiplexing mode (SDM) between an IAB node's parent link and child link are supported.

Therefore, it is desirable to provide detailed solutions for resource multiplexing of the different multiplexing modes.

### SUMMARY

One embodiment of the present disclosure provides a method, comprising: receiving a first signaling via a first link, wherein the first signaling indicates a first time domain resource configuration of at least one multiplexing mode for the first link and a second link, and wherein the at least one multiplexing mode includes at least one of the following multiplexing mode: downlink transmission on the first link and uplink transmission on the second link via a frequency-division multiplexing mode (FDM); downlink transmission on the first link and uplink transmission on the second link via a space division multiplexing mode (SDM); downlink reception on the first link and uplink reception on the second link via the FDM; downlink reception on the first link and uplink reception on the second link via the SDM; uplink transmission on the first link and uplink reception on the second link via the FDM; uplink transmission on the first link and uplink reception on the second link via the SDM; downlink reception on the first link and downlink transmission on the second link via the FDM; downlink reception on the first link and downlink transmission on the second link via the SDM; a time-division multiplexing mode (TDM); a flexible multiplexing mode; and determining time domain resources associated with each multiplexing mode of the at least one multiplexing mode based on the first time domain resource configuration.

In an embodiment, the first signaling comprises a periodicity and an offset of the first time domain resource configuration.

In an embodiment, the first signaling comprises a number of slots or symbols for each multiplexing mode within the periodicity.

In an embodiment, the method further comprises: determining an order for the at least one multiplexing modes within the periodicity.

In an embodiment, the order is predefined in a specification or configured by a high layer signaling.

In an embodiment, multiple patterns within the periodicity are predefined or configured by a high layer signaling.

In an embodiment, the first signaling further comprises an index of a pattern among the multiple patterns.

In an embodiment, a group of time domain resources for each multiplexing mode is predefined or configured by a high layer signaling.

In an embodiment, the method further comprises: receiving a second signaling indicating one or more multiplexing modes for each group.

In an embodiment, the method further comprises: receiving a third signaling indicating a first gap between two multiplexing modes of the at least one multiplexing modes.

In an embodiment, the method further comprises: receiving a fourth signaling indicating whether the first gap is located at an end of a multiplexing mode in time domain, or at a beginning of a multiplexing mode in time domain.

In an embodiment, the method further comprises: receiving a fifth signaling indicating a second time domain resource configuration of the flexible multiplexing mode, wherein the flexible multiplexing mode is associated with a default multiplexing mode, and the default multiplexing mode is the TDM; and the flexible multiplexing mode can be further indicated to be at least one of the following multiplexing modes: transmission on both the first link and the second link via the FDM; transmission on both the first link and the second link via the SDM; reception on both the first link and the second link via the FDM; reception on both the first link and the second link via the SDM; transmission on the first link and reception on the second link via the FDM; transmission on the first link and reception on the second link via the SDM; reception on the first link and transmission on the second link via the FDM; reception on the first link and transmission on the second link via the SDM; or a TDM mode.

In an embodiment, the time domain resources for the flexible multiplexing mode are associated with one or more multiplexing modes.

In an embodiment, in the case that the time domain resources for flexible multiplexing mode are associated with multiple multiplexing modes, each multiplexing mode is associated with corresponding time domain resources.

In an embodiment, the method further comprises: receiving a sixth signaling indicating at least one of a second gap between reception of the fifth signaling and application of the fifth signaling, a third gap between two different multiplexing modes within the time domain resources associated with the flexible multiplexing mode, and a duration for each multiplexing mode within the time domain resource associated with the flexible multiplexing mode.

In an embodiment, the method further comprises: receiving a seventh signaling indicating a number of time domain resources where the fifth signaling is applied.

In an embodiment, a symbol or slot length of the time domain resources is determined by a subcarrier spacing (SCS), and the SCS is explicitly configured or implicitly determined by at least one of SCS for downlink control information (DCI) 2_0, DCI 2_5, frequency band, Synchronization Signal Block (SSB) SCS, or Control Resource Set (corset) SCS.

In an embodiment, the first signaling is applied to at least one of downlink and uplink time domain resources.

Still another embodiment of the present disclosure provides a method, comprising, receiving an availability indication (AI) included in group common downlink control information (DCI) via a first link, wherein the AI indicates availability information of frequency domain soft resources, and wherein the AI is associated with a first number of time domain resources and the AI is to be applied to a second number of time domain resources of a second link; and determining availability of frequency domain soft resources for the second number of time domain resources.

In an embodiment, the AI is to be applied to at least one of downlink and uplink time domain resources.

In an embodiment, the first number of time domain resources includes time domain resources associated with FDM multiplexing mode between the first link and the second link, and time domain resources associated with flexible multiplexing mode.

In an embodiment, the first number of time domain resources includes time domain resources associated with any multiplexing mode.

In an embodiment, the second number of time domain resources includes time domain resources determined to be associated with FDM multiplexing mode between the first link and the second link.

In an embodiment, the AI indicates an availability pattern among multiple availability patterns, and wherein each availability pattern is associated with one or more resource block groups (RBG).

Still another embodiment of the present disclosure provides a method, comprising: transmitting a first signaling via a first link, wherein the first signaling indicates a first time domain resource configuration of at least one multiplexing mode for the first link and a second link, and wherein the at least one multiplexing mode includes at least one of the following multiplexing mode: transmission on both the first link and the second link via a frequency-division multiplexing mode (FDM); transmission on both the first link and the second link via a space division multiplexing mode (SDM); reception on both the first link and the second link via the FDM; reception on both the first link and the second link via the SDM; transmission on the first link and reception on the second link via the FDM; transmission on the first link and reception on the second link via the SDM; reception on the first link and transmission on the second link via the FDM; reception on the first link and transmission on the second link via the SDM; a time-division multiplexing mode (TDM); and a flexible multiplexing mode.

In an embodiment, the first signaling comprises a periodicity and an offset of the first time domain resource configuration.

In an embodiment, the first signaling comprises a number of slots or symbols for each multiplexing mode within the periodicity.

In an embodiment, multiple patterns within the periodicity are predefined or configured by a high layer signaling.

In an embodiment, the first signaling further comprises an index of a pattern among the multiple patterns.

In an embodiment, a group of time domain resources for each multiplexing mode is predefined or configured by a high layer signaling.

In an embodiment, the method further comprises: transmitting a second signaling indicating one or more multiplexing modes for each multiplexing group.

In an embodiment, the method further comprises: transmitting a third signaling indicating a first gap between two multiplexing modes of the at least one multiplexing modes.

In an embodiment, the method further comprises: transmitting a fourth signaling indicating whether the first gap is located at an end of a multiplexing mode in time domain, or at a beginning of a multiplexing mode in time domain.

In an embodiment, the method further comprises: transmitting a fifth signaling indicating a second time domain resource configuration of the flexible multiplexing mode, wherein the flexible multiplexing mode is a default multiplexing mode, and wherein the default multiplexing mode is the TDM; or wherein the flexible multiplexing mode includes at least one of the following multiplexing modes: transmission on both the first link and the second link via the FDM; transmission on both the first link and the second link via the SDM; reception on both the first link and the second link via the FDM; reception on both the first link and the second link via the SDM; transmission on the first link and reception on the second link via the FDM; transmission on the first link and reception on the second link via the SDM; reception on the first link and transmission on the second link via the FDM; reception on the first link and transmission on the second link via the SDM; or a TDM mode.

In an embodiment, time domain resources for the flexible multiplexing mode are associated with one or more multiplexing modes.

In an embodiment, in the case that the flexible multiplexing mode is associated with multiple multiplexing modes, each multiplexing mode of the flexible multiplexing modes is associated with corresponding time domain resources.

In an embodiment, the method further comprises: transmitting a sixth signaling indicating a second gap between reception of the fifth signaling and a beginning of the flexible multiplexing mode.

In an embodiment, the method further comprises: transmitting a seventh signaling indicating a time domain duration for application of the fifth signaling.

In an embodiment, a symbol or slot length of the time domain resource is determined by a subcarrier spacing (SCS), and the SCS is explicitly configured or implicitly determined by at least one of SCS for downlink control information (DCI) 2_0, DCI 2_5, frequency band, Synchronization Signal Block (SSB) SCS, or Control Resource Set (corset) SCS.

In an embodiment, the first signaling is applied to at least one of downlink and uplink time domain resources.

Still another embodiment of the present disclosure provides a method, comprising, transmitting an availability indication (AI) included in group common downlink control information (DCI) via a first link, wherein the AI indicates availability information of frequency domain soft resources, and wherein the AI is associated with a first number of time domain resources and the AI is to be applied to a second number of time domain resources of a second link.

In an embodiment, the AI is to be applied to at least one of downlink and uplink time domain resources.

In an embodiment, the first number of time domain resources includes time domain resources associated with FDM between the first link and the second link, and/or time domain resources associated with flexible multiplexing mode.

In an embodiment, the first number of time domain resources includes time domain resources associated with any multiplexing mode.

In an embodiment, the second number of time domain resources includes time domain resources associated with FDM multiplexing mode between the first link and the second link.

In an embodiment, the AI indicates an availability pattern among multiple availability patterns, and wherein each availability pattern is associated with one or more resource block groups (RBG).

Still another embodiment of the present disclosure provides an apparatus, comprising: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions, when executed by the processor, cause the apparatus to implement the method, comprising: receiving a first signaling via a first link, wherein the first signaling indicates a first time domain resource configuration of at least one multiplexing mode for the first link and a second link, and wherein the at least one multiplexing mode includes at least one of the following multiplexing mode: downlink transmission on the first link and uplink transmission on the second link via a frequency-division multiplexing mode (FDM); downlink transmission on the first link and uplink transmission on the second link via a space division multiplexing mode (SDM); downlink reception on the first link and uplink reception on the second link via the FDM; downlink reception on the first link and uplink reception on the second link via the SDM; uplink transmission on the first link and uplink reception on the second link via the FDM; uplink transmission on the first link and uplink reception on the second link via the SDM; downlink reception on the first link and downlink transmission on the second link via the FDM; downlink reception on the first link and downlink transmission on the second link via the SDM; a time-division multiplexing mode (TDM); a flexible multiplexing mode; and determining time domain resources associated with each multiplexing mode of the at least one multiplexing mode based on the first time domain resource configuration.

### BRIEF DESCRIPTION OF THE DRAWINGS

FIG. 1 illustrates an exemplary IAB system according to some embodiments of the present application.

FIG. 2 illustrates an exemplary description of the links between the IAB nodes according to some embodiments of the present disclosure.

FIGS. 3A and 3B illustrate some examples for time domain resource division for different multiplexing modes according to some embodiments of the present disclosure.

FIGS. 4A-4C illustrate some other examples for time domain resource division for different multiplexing modes according to some embodiments of the present disclosure.

FIGS. 5A and 5B illustrate some embodiments for availability indication for FDM according to some embodiments of the present disclosure.

FIGS. 6A and 6B illustrate other embodiments for availability indication for FDM according to some embodiments of the present disclosure.

FIG. 7 illustrates a flow chart of a method for resource multiplexing according to some embodiments of the present application.

FIG. 8 illustrates a flow chart of a method for determining availability of frequency domain soft resources according to some embodiments of the present application.

FIG. 9 illustrates an exemplary block diagram of an apparatus according to some embodiments of the present application.

### DETAILED DESCRIPTION

The detailed description of the appended drawings is intended as a description of the currently preferred embodiments of the present invention, and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

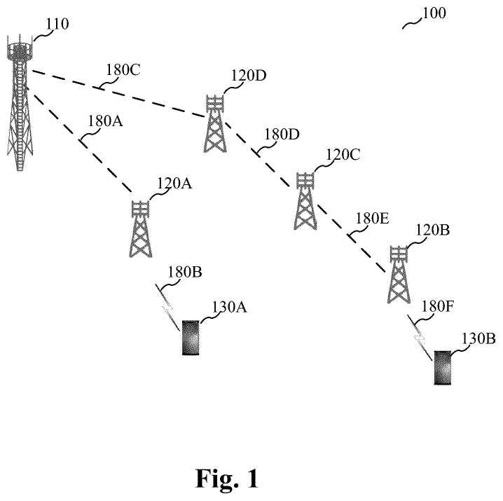

FIG. 1 illustrates an exemplary IAB system 100 according to some embodiments of the present application.

Referring to FIG. 1, the IAB system 100 can include an IAB donor node (e.g., donor node 110), some IAB nodes (e.g., IAB node 120A, IAB node 120B, IAB node 120C, and IAB node 120D), and some UEs (e.g., UE 130A and UE 130B). Although merely, for simplicity, one donor node is illustrated in FIG. 1, it can be contemplated that IAB system 100 may include more donor node(s) in some other embodiments of the present application. Similarly, although merely four IAB nodes are illustrated in FIG. 1 for simplicity, it can be contemplated that IAB system 100 may include more or fewer IAB nodes in some other embodiments of the present application. Although merely two UEs are illustrated in FIG. 1 for simplicity, it can be contemplated that IAB system 100 may include more or fewer UEs in some other embodiments of the present application.

IAB node 120A is directly connected to donor node 110. IAB node 120D is directly connected to donor node 110. In this example, donor node 110 is a parent node of IAB node 120A, and also a parent node of IAB node 120D. IAB nodes 120A and 120D are child nodes of donor node 110. Link 180A between donor node 110 and IAB node 120A is a parent link of IAB node 120A. Link 180B between IAB node 120A and the UE 130A is a child link of IAB node 120A. Link 180C between donor node 110 and IAB node 120D is a parent link of IAB node 120D. IAB node 120A can be connected to donor node(s) other than the donor node 110 in accordance with some other embodiments of the present application. IAB node 120D can be connected to donor node(s) other than the donor node 110 in accordance with some other embodiments of the present application.

IAB node 120C can reach donor node 110 by hopping through IAB node 120D. IAB node 120D is a parent node of IAB node 120C, and IAB node 120C is a child node of IAB node 120D. Link 180D between IAB node 120D and IAB node 120C is a child link of IAB node 120D, and also a parent link of IAB node 120C.

IAB node 120B can reach donor node 110 by hopping through IAB node 120C and IAB node 120D. IAB node 120C and IAB node 120D are upstream nodes of IAB node 120B, and IAB node 120C is a parent node of IAB node 120B. In other words, IAB node 120B is a child node of IAB node 120C. IAB node 120B and IAB node 120C are downstream nodes of IAB node 120D. Link 180E between IAB node 120C and IAB node 120B is a child link of IAB node 120C, and also a parent link of IAB node 120B.

UE 130A is directly connected to IAB node 120A via link 180B, and UE 130B is directly connected to IAB node 120B via link 180F. In other words, UE 130A and UE 130B can be served by IAB node 120A and IAB node 120B, respectively. In some other embodiments of the present application, UE 130A and UE 130B may also be referred to as child nodes of IAB node 120A and IAB node 120B, respectively. Link 180B is a child link of IAB node 120A. Link 180F is a child link of IAB node 120B.

Each of IAB node 120A, IAB node 120B, IAB node 120C, and IAB node 120D can be directly connected to one or more UEs in accordance with some other embodiments of the present application.

Each of IAB node 120A, IAB node 120B, IAB node 120C, and IAB node 120D can be directly connected to one or more IAB nodes in accordance with some other embodiments of the present application.

In Release NR 16 Integrated Access and Backhaul (IAB), time-division multiplexing mode (TDM) is supported. In Release NR 17 IAB, frequency-division multiplexing mode (FDM) and space division multiplexing mode (SDM) are also supported, that is, different multiplexing modes may coexist in the network.

There are several manners for multiplexing these modes. In one embodiment, the multiplexing modes may include at least one of TDM, FDM, SDM and a flexible multiplexing mode. The flexible multiplexing mode has a default multiplexing mode of TDM, and can be further changed to be at least one of TDM, FDM, and SDM. The multiplexing mode relates to two adjacent links, e.g. the parent link and the child link of an IAB node. When TDM multiplexing mode is adopted for the parent link and the child link, it means that different time domain resources are used for communication on the parent link and the child link. When FDM multiplexing mode is adopted for the parent link and the child link, it means that different frequency domain resources are used for communication on different links. When SDM multiplexing mode is adopted for the parent link and the child link, it means that different spatial domain resources are used for communication on different links.

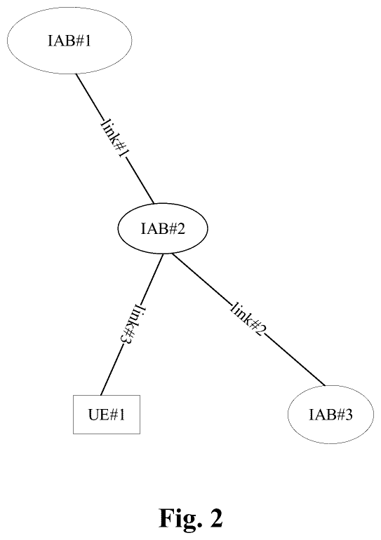

FIG. 2 illustrates an exemplary description of the links between the IAB nodes according to some embodiments of the present disclosure.

In FIG. 2, there are three IAB nodes, IAB #1, IAB #2, and IAB #3, and a UE, i.e. UE #1. IAB #1 is considered as the parent node for IAB #2, and IAB #3 is considered as child nodes for IAB #2. UE #1 is the served UE served by IAB #2. From IAB #2's point of view, link #1 is the parent link for IAB #2, and link #2 is the child link for IAB #2, and link #3 is the access link of IAB #2.

There are multiple multiplexing modes regarding different links, for example:
a) Multiplexing mode A: simultaneous uplink transmission on the parent link and downlink transmission on the child link from IAB #2's perspective;
b) Multiplexing mode B: simultaneous downlink reception on the parent link and uplink reception on the child link from IAB #2's perspective;
c) Multiplexing mode C: simultaneous uplink transmission on the parent link and uplink reception on the child link from IAB #2's perspective; and
d) Multiplexing mode D: simultaneous downlink reception on the parent link and downlink transmission on the child link from IAB #2's perspective.

In this case, the multiplexing modes may include at least one of: mode A, mode B, mode C, mode D, TDM, and the flexible multiplexing mode. The flexible multiplexing mode has a default multiplexing mode, which is TDM, and can be further changed to be at least one of TDM, FDM, and SDM.

The multiplexing mode A may include the following two different multiplexing modes:
1) Multiplexing mode A1: simultaneous uplink transmission on the parent link and downlink transmission on the child link via FDM, i.e. from IAB #2's perspective, uplink transmission on the parent link and downlink transmission on the child link are separated by different frequency domain resources; and
2) Multiplexing mode A2: simultaneous uplink transmission on the parent link and downlink transmission on the child link via SDM, i.e., from IAB #2's perspective, uplink transmission on the parent link and downlink transmission on the child link are separated by different spatial domain resources.

Similarly, multiplexing mode B may include the following two different multiplexing modes:
1) Multiplexing mode B1: simultaneous downlink reception on the parent link and uplink reception on the child link via FDM, i.e., from IAB #2's perspective, downlink reception on the parent link and uplink reception on the child link are separated by different frequency domain resources; and
2) Multiplexing mode B1: simultaneous downlink reception on the parent link and uplink reception on the child link via SDM, i.e. from IAB #2's perspective, downlink reception on the parent link and uplink reception on the child link are separated by different spatial domain resources.

Similarly, multiplexing mode C may include the following two different multiplexing modes:
1) Multiplexing mode C1: simultaneous uplink transmission on the parent link and uplink reception on the child link via FDM, i.e. from IAB #2's perspective, uplink transmission on the parent link and uplink reception on the child link are separated by different frequency domain resources; and
2) Multiplexing mode C2: simultaneous uplink transmission on the parent link and uplink reception on the child link via SDM, i.e. from IAB #2's perspective, uplink transmission on the parent link and uplink reception on the child link are separated by different spatial domain resources.

Similarly, multiplexing mode D may include the following two different multiplexing modes:
1) Multiplexing mode D1: simultaneous downlink reception on the parent link and downlink transmission on the child link via FDM, i.e. from IAB #2's perspective, downlink reception on the parent link and downlink transmission on the child link are separated by different frequency domain resources; and
2) Multiplexing mode D2: simultaneous downlink reception on the parent link and downlink transmission on the child link via SDM, i.e. from IAB #2's perspective, downlink reception on the parent link and downlink transmission on the child link are separated by different spatial domain resources.

In this case, the multiplexing modes may include at least one of: multiplexing mode A1, multiplexing mode A2, multiplexing mode B1, multiplexing mode B2, multiplexing mode C1, multiplexing mode C2, multiplexing mode D1, multiplexing mode D2, TDM, and the flexible multiplexing mode. The flexible multiplexing mode has a default mode as TDM and it can be further changed to be at least one of multiplexing mode A1, multiplexing mode A2, multiplexing mode B1, multiplexing mode B2, multiplexing mode C1, multiplexing mode C2, multiplexing mode D1, multiplexing mode D2, and multiplexing mode TDM.

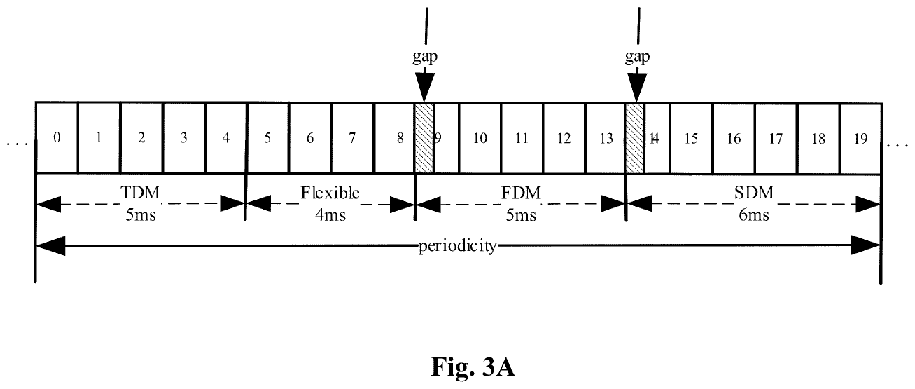

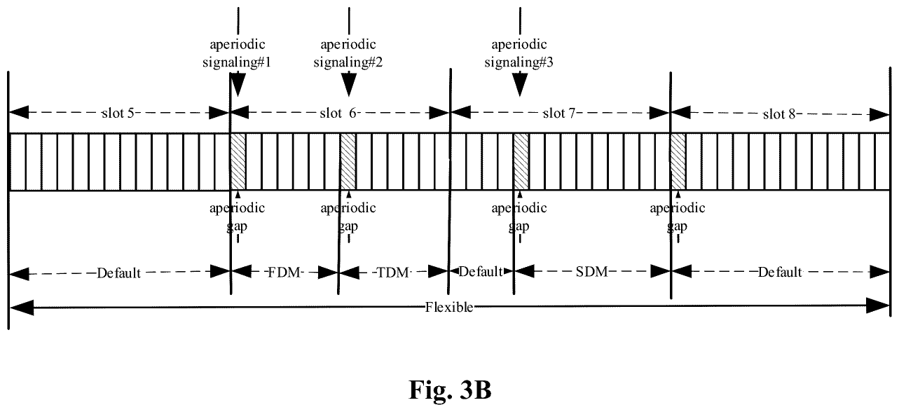

FIGS. 3A and 3B illustrate some examples for time domain resource division for different multiplexing modes according to some embodiments of the present disclosure.

FIG. 3A depicts one periodicity of multiple periodicities; within the periodicity, there are four multiplexing modes: TDM, the Flexible mode, FDM, and SDM. The number of time domain resources associated with TDM is 5 ms, the number of time domain resources associated with the Flexible mode is 4 ms, the number of time domain resources associated with FDM is 5 ms, and the number of time domain resources associated with SDM is 6 ms. The periodicity includes 20 blocks, block 0, block 1, . . . , and block 19, each block may represent a slot, or one millisecond. There is a gap between the Flexible mode and the FDM, and a gap between FDM and SDM. The gap is used for at least one of: transition between transmission and reception from IAB #2's perspective, transition between transmission or reception with different frequency domain resources, transition between transmission or reception with different spatial domain filters. E.g. For transition from multiplexing mode FDM to SDM, the associated frequency and spatial domain resource may be changed, so a gap is necessary. For transition from flexible mode to multiplexing mode FDM, if the flexible mode is set to be default multiplexing mode TDM, there may be transition between transmission and reception at IAB #2, so a gap is necessary. If the flexible mode is set to be FDM, the gap can be set to be 0.

In FIG. 3A, the multiplexing modes are periodically allocated with time domain resources. A periodicity and an offset may be configured by higher signaling. An IAB node can determine the multiplexing modes based on the periodicity and the offset. There are several options to divide the time domain resource within a periodicity.

Option 1: the time domain resource allocation for each multiplexing mode is based on the number of slots or symbols for each multiplexing mode, and an order of the multiplexing modes. Alternatively, the number of slots or symbols can be replaced by the ratio of each multiplexing mode or the length of time domain resource. The order of the multiplexing modes can be predefined in specification or configured by high layer signaling.

For example, in FIG. 3A, the domain resource allocation for each multiplexing mode is based on the length of duration. Specifically, the length of the time domain resource associated with TDM is 5 ms, the length of the time domain resource associated with the flexible multiplexing mode is 4 ms, the length of the time domain resource associated with FDM is 5 ms, and the length of the time domain resource associated with SDM is 6 ms. The order of the multiplexing modes is: the first multiplexing mode is TDM, the second multiplexing mode is the flexible multiplexing mode, the third multiplexing mode is FDM, and the fourth multiplexing mode is SDM.

Alternatively, in FIG. 3A, the domain resource allocation for each multiplexing mode can be based on the number of slots. Specifically, if SCS is 15 KHz, the number of slots of the time domain resource associated with TDM is 5, the number of slots of the time domain resource associated with the flexible multiplexing mode is 4, the number of slots of the time domain resource associated with FDM is 5, and the number of slots of the time domain resource associated with SDM is 6.

In other embodiments, the domain resource allocation for each multiplexing mode is the ratio for each multiplexing mode, for example, in FIG. 3A, the duration of the time domain resource associated with the first mode is 25% of the period, the duration of the time resource associated with the second mode is 20% of the period, etc.

Option 2: multiple time domain resource allocation patterns may be predefined or configured by radio resource control (RRC) signaling, and an additional signaling is used to indicate one of the patterns.

For example, table 1 below shows multiple time domain resource allocation patterns.

TABLE 1
time domain resource allocation patterns

| | Multiplexing | Multiplexing | | Multiplexing |
|---|---|---|---|---|
| | mode 1 | mode 2 | . . . | mode N |
| 1 | 5 slots | 4 slots | . . . | 6 slots |
| 2 | 5 slots | 3 slots | . . . | 6 slots |
| 3 | 20% | 30% | . . . | 20% |

. . .

There are N multiplexing modes in table 1, multiplexing mode 1, multiplexing mode 2, . . . multiplexing mode N, which may include the above mentioned FDM, TDM, SDM, flexible multiplexing mode, multiplexing mode A1, multiplexing mode A2, etc. Time domain resource allocation patterns such as table 1, may be predefined or configured by RRC signaling. An additional signaling is transmitted from the parent node (e.g. IAB #1) to the IAB node (e.g. IAB #2), which includes an index of a time domain resource allocation pattern, e.g. Index #2, and the IAB node determines the domain resource allocation for each multiplexing mode (e.g. the row with index #2 in Table 1). Combined with the periodicity and an offset configured by higher signaling, the IAB node determines the multiplexing modes and the duration for each multiplexing mode.

Option 3: time domain resource allocation pattern can be divided into multiple groups, and each group is indicated to be associated with one multiplexing mode.

For example, the periodicity is divided into four groups, each group is associated with 5 slots, and further signaling indicates that the first group is associated with multiplexing mode TDM, the second group is associated with multiplexing mode TDM, the third group is associated with multiplexing mode FDM, and the fourth group is associated with multiplexing mode SDM.

To transit between different multiplexing modes, gaps are required to prepare for the transition. In FIG. 3A, there is a gap between the flexible multiplexing mode and the FDM multiplexing mode, and a gap between the FDM multiplexing mode and the SDM multiplexing mode. The duration of the gap can be configured by RRC signaling or Media Access Control Control Element (MAC CE), and the location of the gap may be configured or predefined. For example, the location can be at the end of the multiplexing mode, or at the beginning of the multiplexing mode, or at the start of the transition or at the end of the transition. In FIG. 3A, the gap is located at the beginning of the multiplexing mode, i.e. the ending of the transition.

Because the default mode of the flexible multiplexing mode is TDM, therefore, there is no gap between the TDM and the flexible multiplexing mode in FIG. 3A, however, if the flexible multiplexing mode is configured as other multiplexing modes except for TDM, then there will be a gap between the TDM multiplexing mode and the flexible multiplexing mode.

FIG. 3B illustrates some examples for time domain resource division for the flexible multiplexing mode according to some embodiments of the present disclosure.

The default multiplexing mode in FIG. 3B is TDM. That is, if the IAB node does not receive any aperiodic signaling during the time duration associated with the flexible multiplexing mode, the multiplexing mode for the time domain resource associated with the flexible multiplexing mode is multiplexing mode TDM.

The flexible multiplexing mode may be changed by the aperiodic signaling. The aperiodic signaling is associated with an application delay (i.e. aperiodic gap) and an application duration. The aperiodic gap can be the same as the gap as in FIG. 3A, that is, the length of the aperiodic gap equals to the length of the gap. The aperiodic gap can be different from the gap, and the duration of the aperiodic gap can be preconfigured, or configured by RRC signaling or MAC CE signaling.

The aperiodic signaling can be associated with a single multiplexing mode. That is, the aperiodic signaling indicates one multiplexing mode. In other embodiment, the aperiodic signaling can be associated with multiple multiplexing modes, and a pattern is defined to determine the association between multiplexing mode and time domain resource. The patterns may be predefined in the specification, or configured by RRC signaling or MAC CE signaling. The duration may also be implicitly determined by the length of the pattern. The pattern may also be indicated with an index indicating a time domain resource allocation pattern, for example, an index indicating a time domain resource allocation pattern similarly as the time domain resource allocation pattern shown in Table 1.

In FIG. 3B, during the time duration of the flexible multiplexing mode, i.e., from slot #5 to slot #8, the IAB node receives three aperiodic signaling. The first aperiodic signaling, i.e. aperiodic signaling #1, indicates that the flexible multiplexing mode is configured as multiplexing mode FDM, and the aperiodic gap between the reception of the aperiodic signaling and the start of time domain resource associated with multiplexing mode FDM is 1 symbol, the duration of the time domain resource associated with multiplexing mode FDM is 7 symbols. The second aperiodic signaling, i.e. aperiodic signaling #2, indicates that the flexible multiplexing mode is configured as multiplexing mode TDM, and the aperiodic gap between the reception of the aperiodic signaling and the start of time domain resource associated with multiplexing mode TDM is 1 symbol, the duration of the time domain resource associated with TDM is 7 symbols. The third aperiodic signaling, i.e. aperiodic signaling #3, indicates that the flexible multiplexing mode is configured as multiplexing mode SDM, and the aperiodic gap between the reception of the aperiodic signaling and the start of time domain resource associated with multiplexing mode SDM is 1 symbol, the duration of the time domain resource associated with SDM is 10 symbols.

The symbol duration or the slot duration may be determined based on the Subcarrier Spacing (SCS). The SCS can be explicitly configured, or implicitly determined based on frequency band, Control Resource Set (CORESET) #0, SCS configuration, Synchronization Signal Block (SSB), Block SCS, or implicitly determined by the SCS associated with downlink control information (DCI) 2_5 for availability indication.

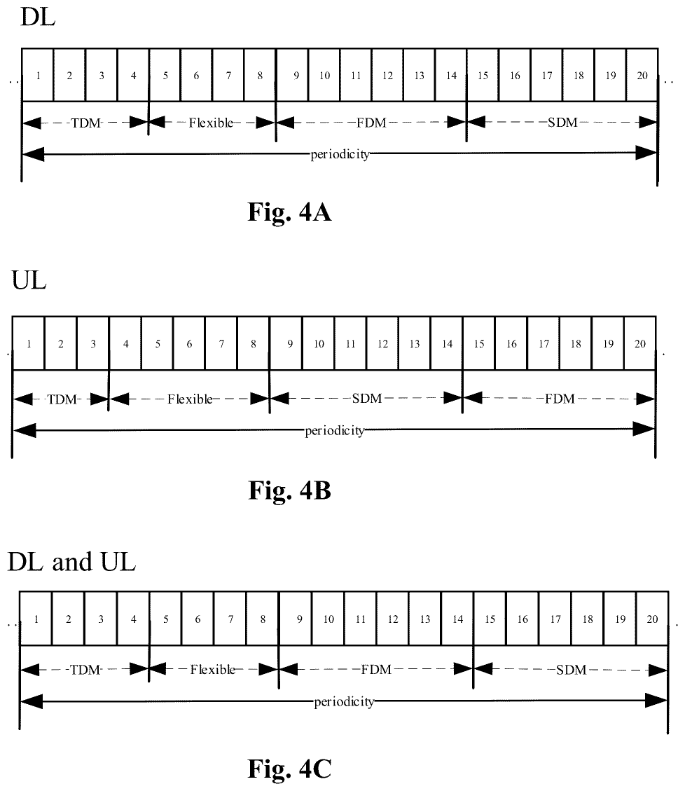

FIGS. 4A-4C illustrate some other examples for time domain resource division for different multiplexing modes according to some embodiments of the present disclosure. Specifically, the time domain resource division for different multiplexing modes for downlink and uplink transmission direction in an LAB distributed unit (DU) may be separately or jointly configured.

In FIGS. 4A-4C, the periodicity is 20 ms, each block in FIGS. 4A-4C represents 1 ms, and the blocks within the multiplexing modes below represent that these time domain resources are associated with the multiplexing modes below. For example, in FIG. 4A, the time domain resources from 1 ms to 4 ms are associated with multiplexing mode TDM.

In FIG. 4A, the indicated multiplexing mode (including both the periodic multiplexing modes and the aperiodic multiplexing modes) for a time domain resource is only applicable to DL slots or DL symbols at the IAB DU.

In FIG. 4B, the indicated multiplexing mode (including both the periodic multiplexing modes and the aperiodic multiplexing modes) for a time domain resource is only applicable to UL slots or UL symbols at IAB DU. As can be seen, the indicated multiplexing mode for DL in FIG. 4A and the indicated multiplexing mode for UL in FIG. 4B are different.

In FIG. 4C, the indicated multiplexing mode (including both the periodic multiplexing modes and the aperiodic multiplexing modes) for a time domain resource is applicable to both DL and UL slots or symbols at IAB DU.

For multiplexing mode FDM, Hard/Soft/Not Available (H/S/NA) indication is supported. A frequency domain resource indicated as hard means the DU can always use the frequency domain resource for communication on the child link. A frequency domain resource indicated as soft means the DU can only use the frequency domain resource for the child link if the frequency domain resource is further indicated as available or determined to be not impacting communication on MT part of the same IAB node. A frequency domain resource indicated as not available means that the DU cannot use the frequency domain resource for communication on its child link. Availability indication (AI) by dynamic signaling for indication of the soft resource is necessary for the DU for communication on its child link. The present disclosure proposes several solutions for indicating the availability of frequency domain soft resource associated with multiplexing mode FDM, and also proposes the coexistence of the AI with the DCI 2_5. DCI 2_5 is used to indicate the availability of time domain resource for the time domain resource associated with multiplexing mode TDM in NR R16.

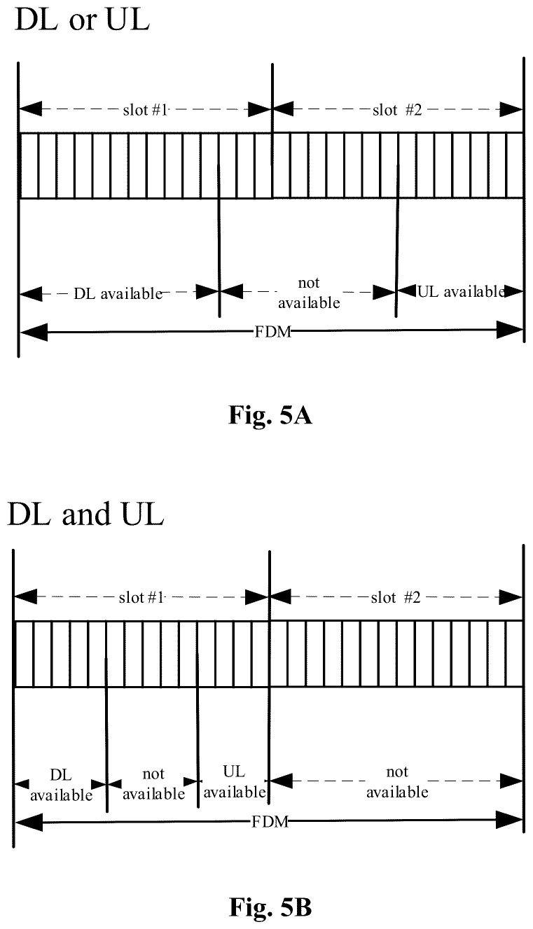

FIGS. 5A and 5B illustrate some embodiments for availability indication for FDM according to some embodiments of the present disclosure.

In FIG. 5A, the AI is applied to the downlink transmission or the uplink transmission of the DU, and in FIG. 5B, the AI is applied to both the downlink transmission and the uplink transmission of the DU.

In the present disclosure, the AI is only applied to downlink and uplink slots or symbols in the IAB DU regarding the availability of the time/frequency/spatial resource of the child link. Regarding the flexible slots or symbols of the IAB DU for the child link, they are considered non-available. The reason is that the flexible slots or symbols can be indicated by DCI signaling as downlink or uplink, however, prior to the corresponding DCI signaling reception, it is hard to judge which multiplexing mode (one of the abovementioned multiplexing mode A, B, C and D) is to be operated between the parent link and the child link, and different multiplexing modes may have different requirements for the time, frequency, spatial resource allocation.

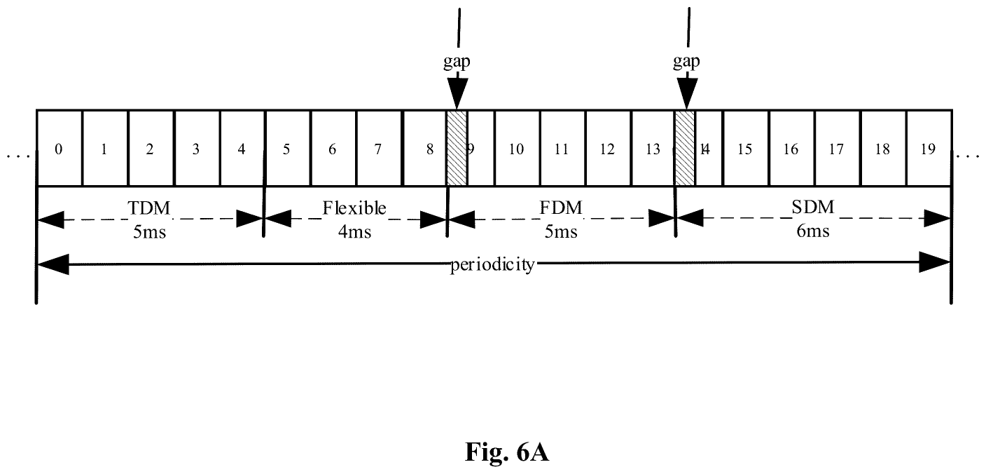

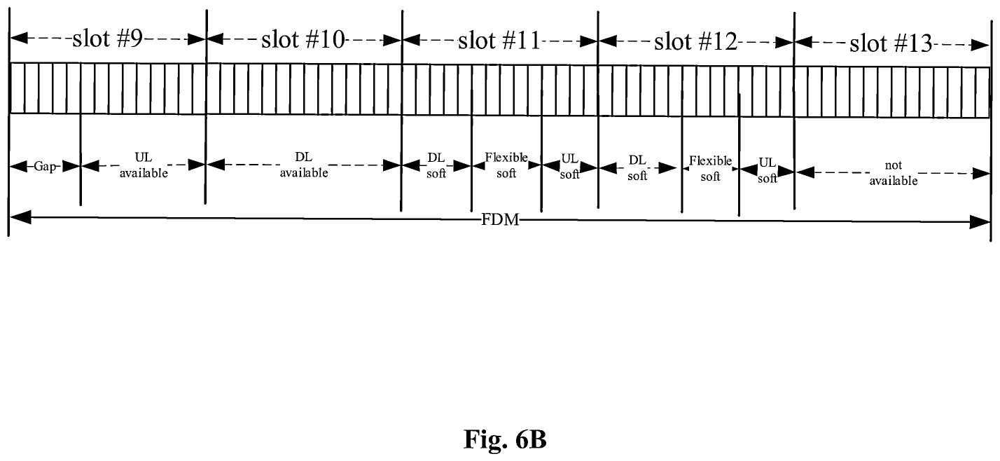

FIGS. 6A and 6B illustrate other embodiments for availability indication for FDM according to some embodiments of the present disclosure.

FIG. 6A depicts one periodicity of multiple periodicities; within the periodicity, there are four multiplexing modes, TDM, the Flexible mode, FDM, and SDM. The length of the time resource associated with TDM is 5 ms, the length of the time resource associated with the Flexible mode is 4 ms, the length of the time resource associated with FDM is 5 ms, and the length of the time resource associated with SDM is 6 ms. The periodicity includes 20 blocks, block 0, block 1, . . . , and block 19, each block may represent a slot, or one millisecond. There is a gap between the Flexible mode and the FDM, and a periodic gap between FDM and SDM.

FIG. 6B depicts the availability information for the FDM resources in FIG. 6A. For example, in slot #9, some symbols belong to the gap between the time domain resource associated with flexible multiplexing mode and the time domain resource associated with FDM, some symbols are UL available, which means the DU can always use the resource for UL transmission. In slot #10, the symbols are DL available, which means the DU can always use the resource for DL transmission. In slot #11 and slot #12, some symbols are DL soft, which means the DU can only use the resource for DL transmission if the resource is indicated as available by DCI, some symbols are flexible soft, which means the DU can't use the resource as it is considered non-available, and other symbols are UL soft, which means the DU can only use the resource for UL transmission if the resource is indicated as available. In slot #13, the symbols are not available.

In order to indicate the availability of the frequency domain resource in time domain resources associated with multiplexing mode FDM indicated as soft, i.e. availability of RBG #1, RBG #2, etc. of slot 11 and slot 12, the AI in group common DCI is necessary. The AI is used to indicate the frequency domain resource availability of multiple time domain resources, so the AI is associated with a number of time domain resources, for example, slots, symbols, etc. The present disclosure proposes the following options to determine application of AI to t the time domain resource.

Option 1: the AI is applied to the time domain resource containing semi-static FDM time domain resource and semi-static flexible time domain resource only. For example, in FIG. 6A, the AI is applied to the time domain resource associated with the flexible multiplexing mode, and the time domain resource associated with multiplexing mode FDM. That is, the time domain resource from block 5 to block 13. In this case, the number of time domain resources associated with the AI indication is 9 slots. In some embodiments, the AI is applied to all time domain resource determined to be FDM. E.g. if slot 6 and slot 7 are determined to be associated with multiplexing mode FDM by aperiodic signaling, and slot 5 and slot 8 are configured to be associated with multiplexing mode SDM, then the AI is only applied to slot 5, slot 8 and slots 9 to 13. In this case, the number of time domain resources associated with AI is 9, and the applied slot number is 7, so there are 2 slots that doesn't apply the AI indication. In other words, the AI is applied to the FDM time domain resource included in the semi-static FDM time domain resource and semi-static flexible time domain resource.

Option 2: the AI is applied to all time domain resource. For example, in FIG. 6A, the AI is applied to all the time domain resource within the periodicity. In this case, the number of time domain resources associated with AI within a periodicity is 20, which is larger than that of option 1. In some embodiments, the AI is applied only when the time domain resource indicated or determined to be FDM. E.g. if slot 6 and slot 7 are indicated to be associated with multiplexing mode FDM, then the AI is applied to slot 6, slot 7, slot 9 to slot 13. Regarding other slots, although there is corresponding indication in the A, the indication is not applicable. In this case, there will be more signaling overhead wasted (e.g. AI indication for 13 slots is not necessary).

One example for FDM availability indication is shown in Table 2:

TABLE 2
availability indication

| Index | AI |
|---|---|
| 00 | DL non-available, UL non-available |
| 01 | DL non-available, UL available |
| 10 | DL available, UL non-available |
| 11 | DL available, UL available |

In some embodiments, the AI for different Resource Block Groups (RBG) may be indicated separately. Suppose there is a RBG, for example, RBG #i, associated with N slots, slot #0, slot #2, . . . , slot #(N-1), and Table 3 shows an availability indication for RBG #i.

TABLE 3
availability indication for a RBG

| | Slot#0 | Slot#1 | | Slot#(N-1) |
|---|---|---|---|---|
| Index | RBG#i | RBG#i | . . . | RBG#i |
| 1 | 00 | 01 | . . . | 10 |
| 2 | 11 | 10 | . . . | 10 |
| . . . | 10 | 00 | . . . | 00 |
| K | 11 | 11 | . . . | 10 |

In Table 3, each index corresponds to an availability indication for the RBG block. For example, if the index is 1, which means that for Slot #0, RBG #i is non-available for DL transmission, and non-available for UL transmission, and for Slot #1, RBG #i is non-available for DL transmission, and available for UL transmission, and for Slot #(N-1), RBG #i is available for DL transmission, and non-available for UL transmission.

In another embodiment, suppose there is M RBGs, RBG #, RBG #1, . . . , and RBG #(M-1), and there are N slots, slot #0, slot #2, . . . , slot #(N-1), and Table 4 shows an availability indication for the time and frequency resources.

TABLE 4
availability indication for M RBGs

| | Slot#0 | | Slot#(N-1) | Slot#0 | | Slot#(N-1) | Slot#0 | | Slot#(N-1) |
|---|---|---|---|---|---|---|---|---|---|
| Index | RBG#0 | . . . | RBG#0 | RBG#1 | . . . | RBG#1 | RBG#(M-1) | . . . | RBG#(M-1) |
| 1 | 00 | . . . | 10 | 01 | | 00 | 10 | | 10 |
| 2 | 11 | . . . | 10 | 10 | | 11 | 10 | | 10 |
| . . . | 10 | . . . | 00 | 00 | | 10 | 00 | | 00 |
| K | 11 | . . . | 10 | 11 | | 11 | 10 | | 10 |

In Table 4, each index corresponds to an availability indication for multiple RBG blocks. For example, if the index is 1, which means that for slot #0, RBG #0 is non-available for DL transmission, and non-available for UL transmission, and for Slot #(N-1), RBG #0 is available for DL transmission, and non-available for UL transmission, . . . and for Slot #(N-1), RBG #(M-1) is available for DL transmission, and non-available for UL transmission.

According to Table 4, it can be seen when number of RBGs is changed, the columns of table 4 is increased or deleted, while the rows of table 4 stays the same. Therefore, the bits required for indicating the availability for the multiple RBGs are not changed.

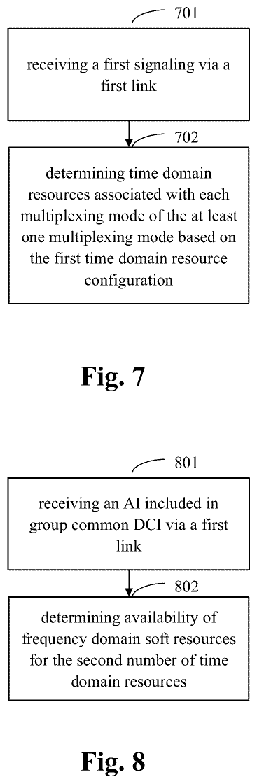

FIG. 7 illustrates a flow chart of a method for resource multiplexing according to some embodiments of the present application, which may be implemented on an IAB node, for example, IAB #2 in FIG. 2.

In operation 701, the IAB node receives a first signaling via a first link, wherein the first signaling indicates a first time domain resource configuration of at least one multiplexing mode for the first link and a second link. For example, the IAB node may receive first signaling from the parent node via the parent link, such as link #1 in FIG. 2. Correspondingly, at the parent node side, the parent node transmits the first signaling via the child link to the IAB node.

The first signaling comprises a periodicity and an offset of the first time domain resource configuration. For example, in FIG. 3A, the periodicity is 20 ms, and the offset is 0.

The at least one multiplexing mode may include at least one of the following multiplexing mode:
DL transmission on the parent link and uplink transmission on the child link via a FDM;
DL on the parent link and uplink transmission on the child link via a SDM;
DL reception on the parent link and uplink reception on the child link via the FDM;
DL reception on the parent link and uplink reception on the child link via the SDM;
UL transmission on the parent link and uplink reception on the child link via the FDM;
UL transmission on the parent link and uplink reception on the child link via the SDM;
DL reception on the parent link and downlink transmission on the child link via the FDM;
DL reception on the parent link and downlink transmission on the child link via the SDM;
TDM; and
a flexible multiplexing mode.

In operation 702, the IAB node determines time domain resources associated with each multiplexing mode of the at least one multiplexing mode based on the first time domain resource configuration.

In some embodiments, the first signaling comprises a number of slots or symbols for each multiplexing mode within the periodicity. For example, in FIG. 3A, each multiplexing mode is associated with a number of slots, a number of symbols, or a length of time duration.

The IAB node also determines an order for the at least one multiplexing modes within the periodicity. For example, the order of the multiplexing modes is: TDM, the flexible multiplexing mode, FDM, and SDM in FIG. 3A. The order can be predefined in the specification or configured by a high layer signaling.

In some embodiments, the multiple patterns within the periodicity can be predefined or configured by a high layer signaling. For example, the high layer signaling indicating that TDM, the flexible multiplexing mode, and FDM are included in the periodicity.

In some other embodiments, the first signaling further comprises an index of a pattern among the multiple patterns. For example, table 1 shows multiple time domain resource allocation patterns, and the first signaling includes an index of the table.

In some other embodiments, a group of time domain resources for each multiplexing mode is predefined or configured by a high layer signaling. The IAB node may further receive a second signaling indicating one or more multiplexing modes for each group.

In some other embodiments, the IAB node may further receive a third signaling indicating a first gap between two multiplexing modes. For example, the periodic gap as shown in FIG. 3A. The IAB node may also receive a fourth signaling indicating whether the first gap is located at an end of a multiplexing mode in time domain, or at a beginning of a multiplexing mode in time domain. In FIG. 3A, the periodic gap is located at the beginning of a multiplexing mode in time domain.

In some other embodiments, the IAB node may further receive a fifth signaling indicating a second time domain resource configuration of the flexible multiplexing mode. The fifth signaling may be aperiodic signaling #1, aperiodic signaling #2, or aperiodic signaling #3 as shown in FIG. 3B. The flexible multiplexing mode is associated with a default multiplexing mode, and the default multiplexing mode may be TDM.

The flexible multiplexing mode may be further indicated to be at least one of the following multiplexing modes:
transmission on both the parent link and the child link via the FDM;
transmission on both the parent link and the child link via the SDM;
reception on both the parent link and the child link via the FDM;
reception on both the parent link and the child link via the SDM;
transmission on the parent link and reception on the child link via the FDM;
transmission on the parent link and reception on the child link via the SDM;
reception on the parent link and transmission on the child link via the FDM;
reception on the parent link and transmission on the child link via the SDM; or
a TDM mode.

The time domain resources for the flexible multiplexing mode are associated with one or more multiplexing modes. In the case that the time domain resources for flexible multiplexing mode are associated with multiple multiplexing modes, each multiplexing mode is associated with corresponding time domain resources.

In some embodiments, the IAB node receives a sixth signaling indicating at least one of a second gap between reception of the fifth signaling and application of the fifth signaling, a third gap between two different multiplexing modes within the time domain resources associated with the flexible multiplexing mode, and a duration for each multiplexing mode within the time domain resource associated with the flexible multiplexing mode. The second gap may be the aperiodic gap as shown in FIG. 3B. The third gap is used in the following scenario: when the fifth signaling indicates more than one multiplexing modes that are associated with the flexible multiplexing mode, for example, multiplexing mode 1 and multiplexing mode 2, then the sixth signaling indicates the second gap between reception of the fifth signaling and application of the fifth signaling, and a third gap between multiplexing mode 1 and multiplexing mode 2.

In some embodiments, the IAB node receives a seventh signaling indicating a number of time domain resources where the fifth signaling is applied.

In some embodiment, the length of a symbol or slot of the time domain resources is determined by a SCS, and the SCS is explicitly configured or implicitly determined by at least one of SCS for DCI 2_0, DCI 2_5, frequency band, SSB SCS, or corset SCS.

In some embodiment, the first signaling is applied to at least one of downlink and uplink time domain resources.

FIG. 8 illustrates a flow chart of a method for determining availability of frequency domain soft resources according to some embodiments of the present application, which may be implemented on an IAB node, for example, IAB #2 in FIG. 2.

In operation 801, the IAB node receives an AI included in group common DCI via a first link, wherein the AI indicates availability information of frequency domain soft resources, and wherein the AI is associated with a first number of time domain resources and the AI is to be applied to a second number of time domain resources of a second link. Correspondingly, at the parent node side, the parent node transmits the AI which is included in the group common DCI via the child link, to the IAB node.

In operation 802, the IAB node determines availability of frequency domain soft resources for the second number of time domain resources. The AI can be applied to at least one of downlink and uplink time domain resources. For example, in FIG. 5A, the AI is applied to DL or UL time domain resources.

In some embodiments, the first number of time domain resources includes time domain resources associated with FDM multiplexing mode between the first link and the second link, and time domain resources associated with flexible multiplexing mode. For example, in FIG. 6A, the first number of time domain resources includes the time domain resources associated with “Flexible” and “FDM”.

In some embodiments, the first number of time domain resources includes time domain resources associated with any multiplexing mode. For instance, in FIG. 6A, the first number of time domain resources includes the time domain resources associated with “TDM”, “Flexible”, “FDM”, and “SDM”.

In some embodiments, the second number of time domain resources includes time domain resources determined to be associated with FDM multiplexing mode between the first link and the second link. In some other embodiments, the AI indicates an availability pattern among multiple availability patterns, and wherein each availability pattern is associated with one or more RBGs. For example, the AI indicates an index in Table 4 above.

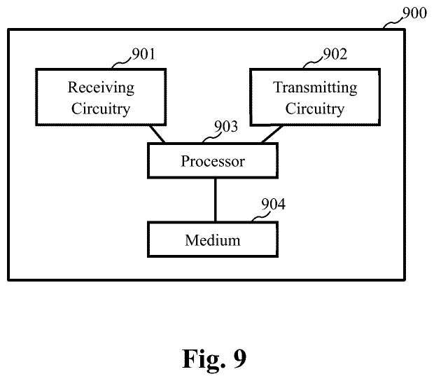

FIG. 9 illustrates an exemplary block diagram of an apparatus 900 according to some embodiments of the present application. In some embodiments of the present application, the apparatus 900 may be an IAB node or other devices having similar functionalities, which can at least perform the method illustrated in FIG. 7 and FIG. 8.

As shown in FIG. 9, the apparatus 900 may include at least one receiving circuitry 901, at least one transmitting circuitry 902, at least one non-transitory computer-readable medium 904, and at least one processor 903 coupled to the at least one receiving circuitry 901, the at least one transmitting circuitry 902, the at least one non-transitory computer-readable medium 904. Although FIG. 9 shows that the at least one receiving circuitry 901, the at least one transmitting circuitry 902, the at least one non-transitory computer-readable medium 904 are directly coupled with the at least one processor 903, it should be understand that all the components in apparatus 900 can be coupled to a data bus so as to be connected and communicate with each other.

Although in FIG. 9, elements such as receiving circuitry 901, transmitting circuitry 902, non-transitory computer-readable medium 904, and processor 903 are described in the singular, the plural is contemplated unless limitation to the singular is explicitly stated. In some embodiments of the present application, the at least one receiving circuitry 901 and the at least one transmitting circuitry 902 can be combined into a single device, such as a transceiver. In certain embodiments of the present application, the apparatus 900 may further include an input device, a memory, and/or other components.

In some embodiments of the present application, the at least one non-transitory computer-readable medium 904 may have stored thereon computer-executable instructions which are programmed to cause the at least one processor 903 to implement the operations of the methods, for example as described in view of FIG. 7 and FIG. 8, with the at least one receiving circuitry 901 and the at least one transmitting circuitry 902. For example, when executed, the instructions may cause the at least one processor 903 to receive, with the at least one receiving circuitry 901, a first signaling via a first link, wherein the first signaling indicates a first time domain resource configuration of at least one multiplexing mode for the first link and a second link. The instructions may further cause the at least one processor 903 to determine time domain resources associated with each multiplexing mode of the at least one multiplexing mode based on the first time domain resource configuration.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. An apparatus, comprising:
a processor; and
a memory coupled with the processor, the processor configured to cause the apparatus to:
receive a first signaling via a first link, wherein the first signaling indicates a first time domain resource configuration of at least one multiplexing mode for the first link and a second link, and wherein the at least one multiplexing mode includes at least one of the following multiplexing modes:
downlink transmission on the first link and uplink transmission on the second link via a frequency-division multiplexing mode (FDM);
downlink transmission on the first link and uplink transmission on the second link via a space division multiplexing mode (SDM);
downlink reception on the first link and uplink reception on the second link via the FDM;
downlink reception on the first link and uplink reception on the second link via the SDM;
uplink transmission on the first link and uplink reception on the second link via the FDM;
uplink transmission on the first link and uplink reception on the second link via the SDM;
downlink reception on the first link and downlink transmission on the second link via the FDM;
downlink reception on the first link and downlink transmission on the second link via the SDM;
a time-division multiplexing mode (TDM); and
a flexible multiplexing mode; and
determine time domain resources associated with each multiplexing mode of the at least one multiplexing mode based on the first time domain resource configuration.

2. The apparatus of claim 1, wherein the first signaling comprises a periodicity and an offset of the first time domain resource configuration.

3. The apparatus of claim 2, wherein the first signaling comprises a number of slots or symbols for each multiplexing mode within the periodicity.

4. The apparatus of claim 2, wherein multiple patterns within the periodicity are predefined or configured by a high layer signaling.

5. The apparatus of claim 1, wherein a group of time domain resources for each multiplexing mode is predefined or configured by a high layer signaling.

6. The apparatus of claim 1, wherein the processor is further configured to cause the apparatus to:
receive a second signaling indicating a first gap between two multiplexing modes of the at least one multiplexing modes.

7. The apparatus of claim 1, wherein the processor is further configured to cause the apparatus to:
receive a third signaling indicating a second time domain resource configuration of the flexible multiplexing mode, wherein the flexible multiplexing mode is associated with a default multiplexing mode, and the default multiplexing mode is the TDM; and
wherein the flexible multiplexing mode is indicated to be at least one of the following multiplexing modes:
transmission on both the first link and the second link via the FDM;
transmission on both the first link and the second link via the SDM;
reception on both the first link and the second link via the FDM;
reception on both the first link and the second link via the SDM;
transmission on the first link and reception on the second link via the FDM;
transmission on the first link and reception on the second link via the SDM;
reception on the first link and transmission on the second link via the FDM;
reception on the first link and transmission on the second link via the SDM; or
a TDM mode.

8. The apparatus of claim 7, wherein time domain resources for the flexible multiplexing mode are associated with one or more multiplexing modes.

9. The apparatus of claim 7, wherein the processor is further configured to cause the apparatus to:
receive a fourth signaling indicating at least one of a second gap between reception of the third signaling and application of the third signaling, a third gap between two different multiplexing modes within the time domain resources associated with the flexible multiplexing mode, and a duration for each multiplexing mode within the time domain resource associated with the flexible multiplexing mode.

10. The apparatus of claim 7, wherein the processor is further configured to cause the apparatus to:
receive a fifth signaling indicating a number of time domain resources where the third signaling is applied.

11. The apparatus of claim 1, wherein a symbol or slot length of the time domain resources is determined by a subcarrier spacing (SCS), and the SCS is explicitly configured or implicitly determined by at least one of SCS for downlink control information (DCI) 2_0, DCI 2_5, frequency band, Synchronization Signal Block (SSB) SCS, or Control Resource Set (corset) SCS.

12. The apparatus of claim 1, wherein the first signaling is applied to at least one of downlink and uplink time domain resources.

13. An apparatus, comprising,
a processor; and
a memory coupled with the processor, the processor configured to cause the apparatus to:
receive an availability indication (AI) included in group common downlink control information (DCI) via a first link, wherein the AI indicates availability information of frequency domain soft resources, and wherein the AI is associated with a first number of time domain resources and the AI is to be applied to a second number of time domain resources of a second link; and
determine availability of frequency domain soft resources for the second number of time domain resources.

14. The apparatus of claim 13, wherein the AI is to be applied to at least one of downlink and uplink time domain resources.

15. The apparatus of claim 13, wherein the first number of time domain resources include time domain resources associated with FDM multiplexing mode between the first link and the second link, and time domain resources associated with flexible multiplexing mode.

16. A processor for wireless communication, comprising:
at least one controller coupled with at least one memory and configured to cause the processor to:
receive a first signaling via a first link, wherein the first signaling indicates a first time domain resource configuration of at least one multiplexing mode for the first link and a second link, and wherein the at least one multiplexing mode includes at least one of the following multiplexing modes:
downlink transmission on the first link and uplink transmission on the second link via a frequency-division multiplexing mode (FDM);
downlink transmission on the first link and uplink transmission on the second link via a space division multiplexing mode (SDM);
downlink reception on the first link and uplink reception on the second link via the FDM;
downlink reception on the first link and uplink reception on the second link via the SDM;
uplink transmission on the first link and uplink reception on the second link via the FDM;
uplink transmission on the first link and uplink reception on the second link via the SDM;
downlink reception on the first link and downlink transmission on the second link via the FDM;
downlink reception on the first link and downlink transmission on the second link via the SDM;
a time-division multiplexing mode (TDM); and
a flexible multiplexing mode; and
determine time domain resources associated with each multiplexing mode of the at least one multiplexing mode based on the first time domain resource configuration.

17. The processor of claim 16, wherein the first signaling comprises a periodicity and an offset of the first time domain resource configuration.

18. The processor of claim 17, wherein the first signaling comprises a number of slots or symbols for each multiplexing mode within the periodicity.

19. A processor for wireless communication, comprising,
at least one controller coupled with at least one memory and configured to cause the processor to:
receive an availability indication (AI) included in group common downlink control information (DCI) via a first link, wherein the AI indicates availability information of frequency domain soft resources, and wherein the AI is associated with a first number of time domain resources and the AI is to be applied to a second number of time domain resources of a second link; and
determine availability of frequency domain soft resources for the second number of time domain resources.

20. The processor of claim 19, wherein the AI is to be applied to at least one of downlink and uplink time domain resources.
